(19) United States
(12) Patent Application Publication
(10) Pub. No.: US 2009/0248073 A1
(43) Pub. Date: Oct. 1, 2009

(54) BABY TEETHING DEVICES HAVING TEETHING RIDGES

(76) Inventors: Adriana B. Kliegman, New York, NY (US); Diana B. Sierra, North Bergen, NJ (US); Pilar Ayarza, North Bergen, NJ (US)

Correspondence Address: OHLANDT, GREELEY, RUGGIERO & PERLE, LLP, 1 LANDMARK SQUARE, 10TH FLOOR, STAMFORD, CT, 06901, US

(21) Appl. No.: 12/410,845

(22) Filed: Mar. 25, 2009

Related U.S. Application Data
(60) Provisional application No. 61/072,134, filed on Mar. 28, 2008.

(51) Int. Cl. A61J 17/00

(52) U.S. Cl. 606/235

(57) ABSTRACT

A baby teething device is provided that includes a shield, a handle depending from the shield, a nipple-like portion depending from the shield opposite the handle, and teething ridges defined on the nipple-like portion. The teething ridges can include a series of generally linear ridges that are substantially parallel to the shield and/or a plurality of concentric teething ridges.

### BACKGROUND OF THE INVENTION

1. Field of the Invention

The present disclosure relates to baby teething devices. More particularly, the present disclosure relates to baby teething devices having a plurality of teething ridges configured to maximize pressure on one or more predetermined portions of a gum line.

2. Description of Related Art

Baby teething devices generally include one or more surfaces upon which the baby or child can chew to relieve the discomfort of teething and assist in erupting the teeth through the overlying layer of gum and tissue.

Baby teething devices have been developed with many different configurations and sizes. Some prior art teething devices have been difficult for the baby to hold and manipulate during use. Other prior art teething devices have proven less than optimal in assisting the baby to erupt the new teeth through the overlaying tissue layer because the size and shape is not optimal to comfortably fit in baby's mouth. Further, other prior art teething devices have proven confusing to the baby as they have an appearance, shape, and/or size that differs from the baby pacifying devices and baby bottle nipples to which these babies have become accustomed.

Accordingly, it has been determined that there is a continuing need for baby teething devices that overcome, alleviate, and/or mitigate one or more of the aforementioned and other deleterious effects of prior art teething devices.

### BRIEF SUMMARY OF THE INVENTION

A baby teething device is provided that includes a shield, a handle depending from the shield, a nipple-like portion depending from the shield opposite the handle, and a plurality of teething ridges defined on the nipple-like portion. The plurality of teething ridges can include a series of generally linear ridges that are substantially parallel to the shield and/or a plurality of concentric teething ridges.

In some embodiments, the shield includes a rigid inner substrate and a flexible outer layer molded over the rigid inner substrate. Here, the handle, nipple-like portion, and plurality of teething ridges are integrally molded with the flexible outer layer.

The inner substrate can include a central opening and a plurality of vent openings, where the outer layer covers and fills in the central opening.

In other embodiments, the handle extends from an outer periphery of the shield so that the handle defines a handle opening substantially equal to a width of the shield.

The vent openings can include a first upstanding rim depending upwardly from a rear surface of the inner substrate and a second upstanding rim depending upwardly from a front surface of the inner substrate. The first upstanding rim depends upwardly by a first height, while the second upstanding rim depends upwardly by a second height. The outer layer can have a thickness substantially equal to the first height in a region of the first upstanding rim and a thickness substantially equal to the second height in a region of the second upstanding rim so that an upper surface of the outer layer is substantially planar with an upper surface of the first and second upstanding rims.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 is a perspective view of a teething device according to the present disclosure having a first exemplary embodiment of teething ridges;

FIG. 2 is a side view of the teething device of FIG. 1, the opposite side view being identical thereto;

FIG. 3 is a top view of the teething device of FIG. 1, the bottom view being identical thereto;

FIG. 4 is a sectional view of the teething device of FIG. 3 taken along lines 4-4;

FIG. 5 is a close-up view of FIG. 4 taken along circle 5;

FIG. 6 is a rear isometric view an exemplary embodiment of an inner substrate of the teething device of FIG. 1;

FIG. 7 is a front isometric view the inner substrate of FIG. 6;

FIG. 8 is a top view of the teething device of FIG. 1, illustrating the outer layer in phantom over the inner substrate;

FIG. 9 is a perspective view of a teething device according to the present disclosure having a second exemplary embodiment of teething ridges;

FIG. 10 is a side view of the teething device of FIG. 9, the opposite side view being identical thereto;

FIG. 11 is a top view of the teething device of FIG. 9, the bottom view being identical thereto;

FIG. 12 is a sectional view of the teething device of FIG. 11 taken along lines 12-12; and

FIG. 13 is a close-up view of FIG. 12 taken along circle 13.

### DETAILED DESCRIPTION OF THE INVENTION

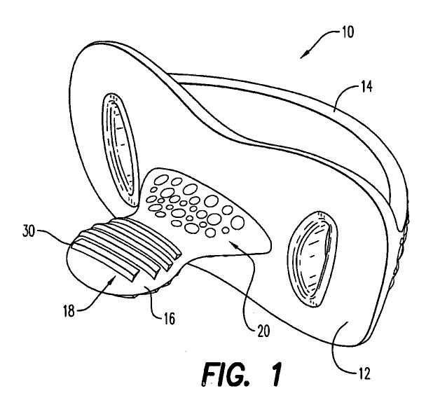

Referring to the drawings and in particular to FIGS. 1 through 4, a baby teething device according to the present disclosure is shown and generally referred to by reference numeral 10.

Teething device 10 includes a shield 12, a handle 14, a nipple-like portion 16, one or more teething ridges 18, and, in some embodiments, one or more teething protuberances 20.

It has been determined by the present disclosure that the shape and position of a baby's front teeth as compared to the baby's back teeth require teething ridges of different configurations to best assist the eruption process. As used herein, the baby's front teeth shall include the central incisors and the lateral incisors, while the baby's back teeth shall include the cuspids and molars

Typically, the front teeth erupt through the overlaying tissue layer between the ages of about 6 months and 23 months, while the back teeth erupt through the overlaying tissue layer at about 13 months. Teething device 10 is configured for use during the eruption of the back teeth and, thus, is configured to maximize point contact with a baby's back teeth.

More particularly, teething device 10 includes teething ridges 18 formed on nipple-like portion 16. Advantageously, teething ridges 18 are configured to maximize point contact with a baby's back teeth. In some embodiments, teething device 10 can include protuberances 20 formed on nipple-like portion 16, which are configured to provide at least some point contact with a baby's front teeth.

Teething ridges 18 are formed on nipple-like portion 16 remote from shield 12, while teething protuberances 20, when present, are formed on nipple-like portion 16 proximate the shield 12. In this manner, teething device 10 can be placed in the baby's mouth such that shield 12 is proximate the baby's face with the proturberances 20 presented to the front teeth and teething ridges 18 presented to the back teeth.

Nipple-like portion 16 provides teething device 10 with a small teething section, having teething ridges and protuberances 18, 20, respectively, that comfortably and safely fits in baby's mouth. The shape of shield 12 and nipple-like portion 16 allows the baby to reach teething ridges and protuberances 18, 20 as localized areas of pressure as opposed to the whole gum-line or a big section of the gum line. Thus, teething device 10 allows for pin-point pressure where the baby needs it most, namely for the back teeth.

Because teething ridges 18 allow the baby to apply their biting force on a small area, the resultant pressure on the tissue in that area is increased as compared to the pressure applied to the tissue when the same biting force is applied on a larger area.

In addition, the shape and size of shield 12 and nipple-like portion 16 provides teething device 10 with the look and feel of a typical pacifier. In this manner, the use of teething device 10 during teething and can help a baby transition from a pacifier device to a teething device and thus, can help to wean the baby from the pacifier device.

Teething device 10 includes a plurality of teething ridges 18. Preferably, teething device 10 includes a plurality of teething ridges 18 on an upper surface 22 of nipple-like portion 16 and a plurality of teething ridges 18 on a lower surface 24 of nipple-like portion 16. Teething ridges 18 are arranged as a series of generally linear ridges (four shown).

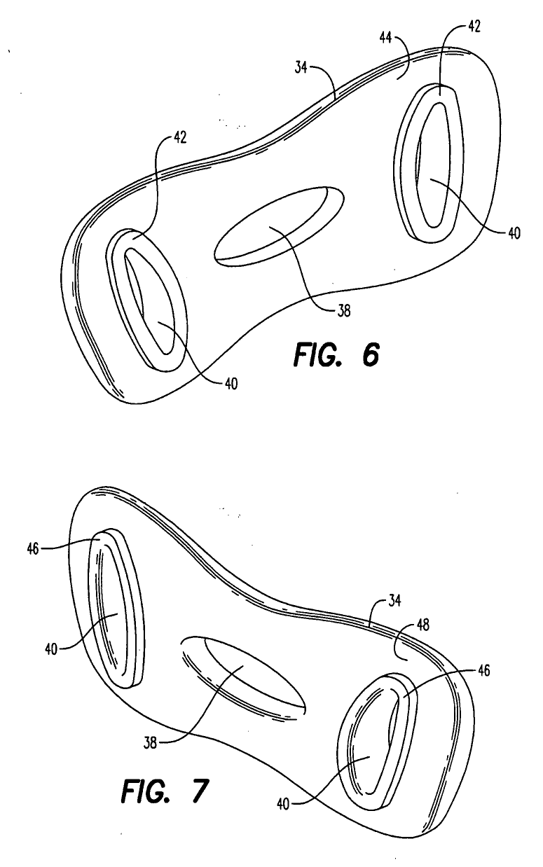

For purposes of clarity, teething ridges 18 are described in detail with reference to FIG. 5 where the teething ridge is shown depending from upper surface 22 of nipple-like portion 16. Ridge 18 includes a first face 26 and a second face 28 depending from surface 22 of nipple-like portion 16. First and second faces 26, 28 meet at an apex 30. Apex 30 can have a radius of between about 0.010 inches to about 0.0 inches and any sub-ranges therebetween, preferably about 0.005 inches

In a preferred embodiment, apex 30 of each teething ridge 18 on both upper and lower surfaces 22, 24 have substantially the same radius. However, it is contemplated for apex 30 of each teething ridge 18 on upper surface 22 to have a different radius from one another, for apex 30 of each ridge 18 on lower surface 24 to have a different radius from one another, for apex 30 of each ridge 18 on the upper surface 22 to have a different radius from those on lower surface 24, and any combinations thereof.

First and second faces 26, 28 define a rake angle 32 therebetween. For example, angle 32 can be between about 110 degrees to about 130 degrees and any sub-ranges therebetween, preferably about 125 degrees.

In a preferred embodiment, each teething ridge 18 of the plurality of teething ridges on both upper and lower surfaces 22, 24 have substantially the same rake angle. However, it is contemplated for each ridge 18 on upper surface 22 to have a different rake angle from one another, for each ridge 18 on lower surface 24 to have a different angle from one another, for each ridge 18 on the upper surface 22 to have a different angle from those on lower surface 24, and any combinations thereof.

In some embodiments, teething ridges 18 are substantially linear as shown in FIG. 3. Here, the teething ridges 18 are generally perpendicular to the length of nipple-like portion 16.

In other embodiments, teething ridges 18 have a radius of curvature (R1) that is not less than about 0.5 inches, more preferably not less than about 1.0 inch. In this manner, teething ridges 18 have a curvature that is substantially parallel to the curvature of shield 12.

Shield 12 has a radius of curvature (R2) that is between about 3.0 inches to about 4.0 inches, preferably about 3.5 inches. The radius of curvature (R2) of shield 12 is configured so that the shield curves away from the baby's face to reduce skin contact and allow the baby to position nipple-like portion 16 in any desired position along the side of their mouth to reach the back teeth.

In a preferred embodiment, teething ridges 18 all have substantially the same radius of curvature. However, it is contemplated for each ridge 18 to have a different radius of curvature or for some of the teething ridges 18 to have substantially the same radius of curvature while other ridges have a different radius of curvature. In embodiments where teething ridges 18 have a different radius of curvature, it is contemplated by the present disclosure for the ridges to have a common center point, namely to be concentric to one another.

Teething device 10 can, in some embodiments, includes a plurality of teething protuberances 20. Preferably, teething device 10 includes a plurality of teething protuberances 20 on upper surface 22 and a plurality of teething protuberances 20 on lower surface 24. Protuberances 20 have a generally semi-spherical shape.

In some embodiments, teething protuberances 20 can have a common radius to one another, while in other embodiments protuberances 20 can have a varied radius to one another. For example, protuberances 20 can have a height of between about 0.02 inches to about 0.10 inches and any sub-ranges therebetween, preferably about 0.04 inches to about 0.08 inches.

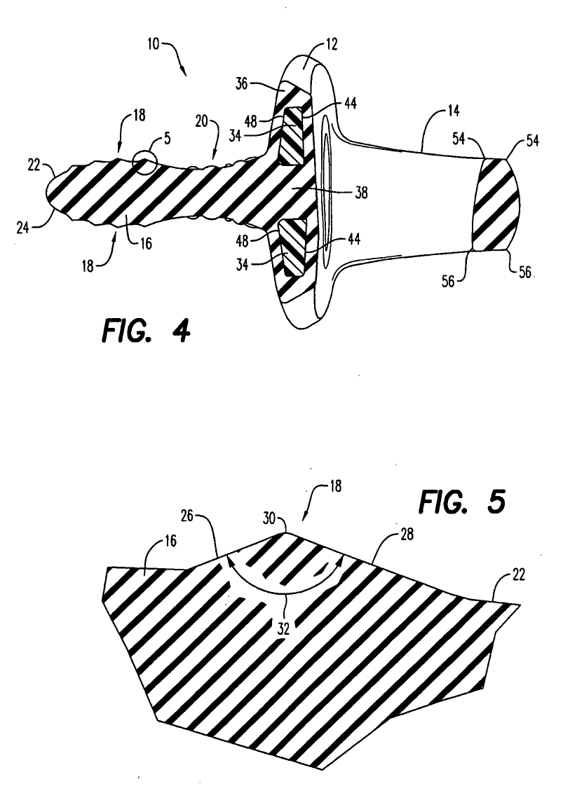

Referring again to FIG. 4, shield 12 includes a rigid inner substrate 34 having a flexible outer layer 36 molded directly over the inner substrate 34. In addition to defining the outer layer 36 of shield 12, the material of outer layer 36 further defines handle 14, nipple-like portion 16, teething ridges 18, and, when present, protuberances 20. Accordingly, teething device 10 provides a one-piece integral design, which reduces component parts and increases manufacturing efficiency.

Inner substrate 34 can be any material having a modulus of rigidity of between about 700 to about 1,600 kilo-pounds per square inch (KSI) and more preferably between about 800 to about 1,200 KSI. Furthermore, inner substrate 34 can be any material having a modulus of elasticity of between 20 to about 1,600 KSI and more preferably between about 100 to about 500 KSI. Finally, inner substrate 34 can be any material having a Rockwell R hardness of between 20 to about 150 and more preferably between about 65 to about 85. For example, inner substrate 34 can be made of any thermoplastic polymer such as, but not limited to, polypropelyne (PP), polyamides (Nylon), acrylonitrile butadiene styrene (ABS), polycarbonate (PC), and any combinations thereof.

The material of outer layer 36 of shield 12 and, thus, of handle 14, nipple-like portion 16, teething ridges 18, and teething protuberances 20, can be any material having a hardness of between about 30 to about 70 (Shore A), and more preferably between about 40 to about 60 (Shore A). For example, outer layer 36 can be made of any thermoplastic elastomer or silicone.

Inner substrate 34 is described with reference to FIGS. 6 and 7. Inner substrate 34 includes a central opening 38 and a plurality of vent openings 40 (only two shown). Vent openings 40 provides ventilation for safety during use of teething device 10. The curvature of the shield which is away from baby's face reduces skin contact and allows baby to put it anywhere along the side of the mouth to reach back teeth and molars.

Vent openings 40 include a first upstanding rim 42 depending upwardly from a rear surface 44 (FIG. 6) and a second upstanding rim 46 depending upwardly from a front surface 48 (FIG. 7). First upstanding rim 42 depends upwardly from rear surface 44 by a first height (H1), while second upstanding rim 46 depends upwardly from front surface 48 by a second height (H2). First and second heights (H1, H2) can be the same as or different from one another as desired.

During over-molding of outer layer 36 on inner substrate 34, the outer layer covers front and rear surfaces 44, 48 of the inner substrate as shown in FIG. 4. In addition, outer layer 36 covers and fills in central opening 38 of inner substrate 36.

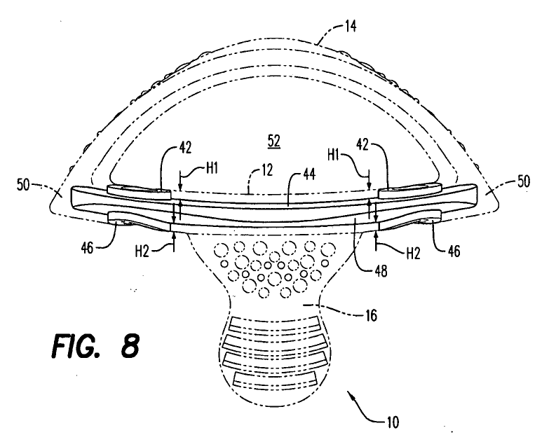

In a preferred embodiment, outer layer 36 has a thickness substantially equal to first height (H1) in the region of first upstanding rim 42 and a thickness substantially equal to second height (H2) in the region of second upstanding rim 44 as shown in FIG. 8. In this manner, the upper surface of outer layer 36 is substantially planar with the upper surface of first and second upstanding rims 42, 44.

Referring to FIGS. 3 and 8, handle 14 extends from an outer periphery 50 of shield 12. It has been determined by the present disclosure that handle 14 extending from outer periphery 50 provides a large handle opening 52, which enhances the ease with which the baby can hold onto the handle during teething. More particularly, handle opening 52 is substantially equal to a width of shield 12.

In addition, handle 14, depending from outer periphery 50 provides a pair of top edges 54 and a pair of bottom edges 56 shown in FIG. 4, which provide additional sharp edges upon which the baby can teeth. For example, edges 54, 56 can have a radius of between about 0.010 inches to about 0.0 inches and any sub-ranges therebetween, preferably about 0.005 inches

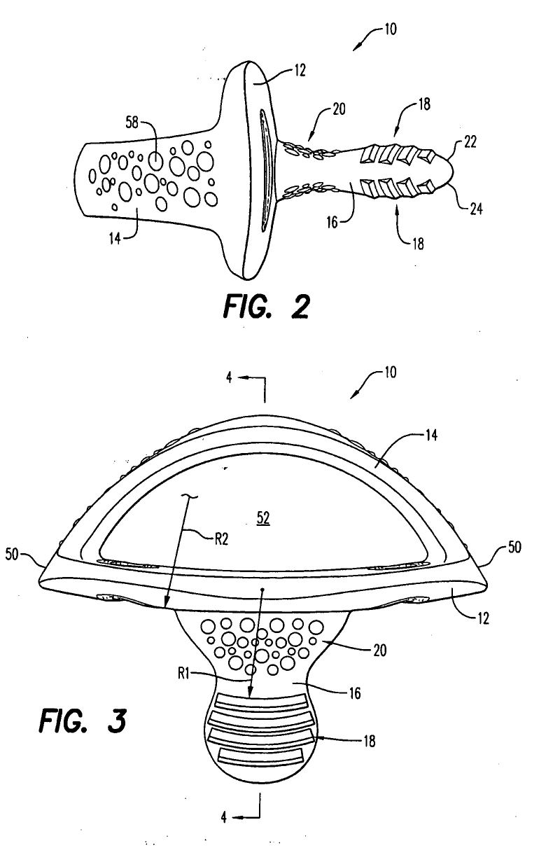

In some embodiments, handle 14 can include a plurality of teething protuberances 58 defined thereon as shown in FIG. 2. Protuberances 58, much like protuberances 20 discussed in detail above, have a generally semi-spherical shape. Protuberances 58 can have a common radius to one another or can have a varied radius to one another. For example, protuberances 58 can have a height of between about 0.02 inches to about 0.15 inches and any sub-ranges therebetween, preferably about 0.04 inches to about 0.08 inches

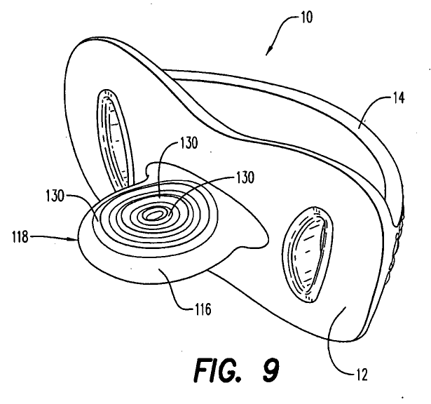

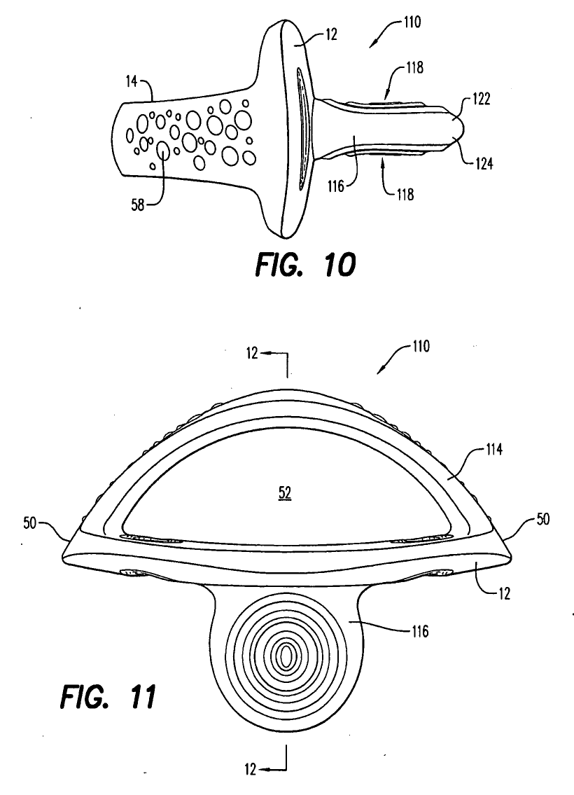

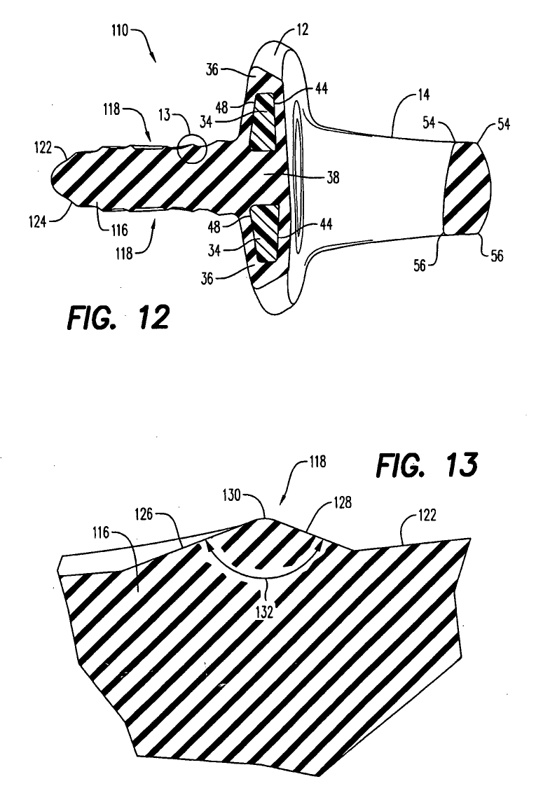

Referring to the drawings and in particular to FIGS. 9 through 12, an alternate embodiment of a baby teething device according to the present disclosure is shown and generally referred to by reference numeral 110.

Teething device 110 includes shield 12 and handle 14 as discussed above with respect to FIGS. 1 through 8. In addition, teething device 110 includes a nipple-like portion 116 having a plurality of concentric teething ridges 118.

Teething ridges 118 on nipple-like portion 116 and are configured to maximize point contact with a baby's front teeth. Since teething device 110 is primarily intended for use in the eruption of the front teeth, namely between the ages of 5 months and 10 months, which typically occurs before the eruption of the back teeth, teething device 110 does not include teething protuberances 20 on nipple-like portion 116.

Rather, teething device 110 includes teething ridges 118 formed on nipple-like portion 116 so that when the teething device 110 is placed in the baby's mouth with shield 12 facing the baby's face, teething ridges 118 are presented to the front teeth.

Nipple-like portion 116, similar to the nipple-like portion 16 discussed above, provides teething device 110 with a small teething section that comfortably and safely fits in baby's mouth. The shape of shield 12 and nipple-like portion 116 allows the baby to reach teething ridges 118 as a localized area of pressure as opposed to the whole gum-line or a big section of the gum line. Thus, teething device 110 allows for pin-point pressure where the baby needs it most, namely for the front teeth.

In addition, the shape and size of shield 12 and nipple-like portion 116 provides teething device 110 with the look and feel of a typical pacifier. In this manner, the use of teething device 110 during teething can help a baby transition from a pacifier to the teething device and thus, can help to wean the baby from a pacifier.

Preferably, teething device 110 includes a plurality of teething ridges 118 on an upper surface 122 of nipple-like portion 116 and a plurality of teething ridges 118 on a lower surface 124 of nipple-like portion 116. Teething ridges 118 are arranged as a series of concentric rings (three shown).

For purposes of clarity, teething ridges 118 are described in detail with reference to FIG. 13 where the ridge is shown depending from upper surface 122 of nipple-like portion 116. Ridge 118 includes a first face 126 and a second face 128 depending from surface 122. First and second faces 126, 128 meet at an apex 130. Apex 130 can have a radius of between about 0.010 inches to about 0.0 inches and any sub-ranges therebetween, preferably about 0.005 inches

In a preferred embodiment, apex 130 of each ridge 118 on both upper and lower surfaces 122, 124 have substantially the same radius. However, it is contemplated for apex 130 of each ridge 118 on upper surface 122 to have a different radius from one another, for apex 130 of each ridge 118 on lower surface 124 to have a different radius from one another, for apex 130 of each ridge 118 on the upper surface 122 to have a different radius from those on lower surface 124, and any combinations thereof.

First and second faces 126, 128 define a rake angle 132 therebetween. For example, angle 132 can be between about 110 degrees to about 130 degrees and any sub-ranges therebetween, preferably about 120 degrees

In a preferred embodiment, each teething ridge 118 of the plurality of teething ridges on both upper and lower surfaces 122, 124 have substantially the same rake angle. However, it is contemplated for each ridge 118 on upper surface 122 to have a different rake angle from one another, for each ridge 118 on lower surface 124 to have a different angle from one another, for each ridge 118 on the upper surface 122 to have a different angle from those on lower surface 124, and any combinations thereof.

It should be noted that teething ridges 118 of teething device 110 find equal use with the embodiment of teething device 10. More particularly, it is contemplated by the present disclosure for teething device 10 to include one or more concentric teething ridges 118 in place of and/or supplementing teething proturberances 20.

Further, it is contemplated by the present disclosure for teething devices 10, 110 to include one or more concentric teething ridges 118 in place of and/or supplementing teething proturberances 58 on handle 14.

Teething devices 10, 110 are sized and configured to meet the current safety requirements for pacifiers set forth in 16 C.F.R. Part 1511 of the U.S. Consumer Product Safety Commission. More particularly, shield 12 is sized and configured to not be so small or flexible that it can be sucked into a child's mouth; handle 14 is not long enough or rigid enough to force teething devices 10, 110 into the child's mouth in the event of a fall; and teething devices 10, 110, as a result of being an integral one-piece device, do not provide small parts.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A baby teething device comprising:
a shield;
a handle depending from said shield;
a nipple-like portion depending from said shield opposite said handle; and
a plurality of teething ridges on said nipple-like portion.

2. The teething device of claim 1, wherein said shield comprises:
a rigid inner substrate; and
a flexible outer layer molded over said rigid inner substrate, wherein said handle, said nipple-like portion and said plurality of teething ridges are integrally molded with said flexible outer layer.

3. The teething device of claim 2, wherein said handle extends from an outer periphery of said shield so that said handle defines a handle opening substantially equal to a width of said shield.

4. The teething device of claim 3, wherein said handle comprises a pair of top edges and a pair of bottom edges, which provide sharp teething edges having a radius of between about 0.010 inches to about 0.0 inches.

5. The teething device of claim 4, further comprising a plurality of teething protuberances on said handle.

6. The teething device of claim 5, wherein each protuberances of said plurality of teething protuberances has a generally semi-spherical shape.

7. The teething device of claim 4, further comprising a plurality of concentric teething protuberances on said handle.

8. The teething device of claim 2, wherein said plurality of teething ridges comprises a series of generally linear ridges.

9. The teething device of claim 8, wherein each ridge of said series of generally linear ridges comprises a radius of curvature that is not less than about 1 inch.

10. The teething device of claim 2, wherein said plurality of teething ridges comprises a plurality of concentric teething ridges.

11. The teething device of claim 2, wherein said inner substrate has a modulus of rigidity of between about 700 to about 1,600 kilo-pounds per square inch.

12. The teething device of claim 2, wherein said inner substrate has a modulus of elasticity of between about 20 to about 1,600 kilo-pounds per square inch.

13. The teething device of claim 2, wherein said inner substrate has a Rockwell R hardness of between about 20 to about 150.

14. The teething device of claim 2, wherein said inner substrate comprises a thermoplastic polymer selected from the group consisting of polypropelyne, polyamide, acrylonitrile butadiene styrene, polycarbonate, and any combinations thereof.

15. The teething device of claim 2, wherein said outer layer comprises a Shore A hardness of between about 30 to about 70.

16. The teething device of claim 2, wherein said outer layer comprises a Shore A hardness of between about 40 to about 60.

17. The teething device of claim 2, wherein said outer layer comprises a thermoplastic elastomer or a silicone material.

18. The teething device of claim 2, wherein said inner substrate comprises a central opening and a plurality of vent openings, said outer layer covering and filling in said central opening.

19. The teething device of claim 18, wherein each vent opening of said plurality of vent openings comprises a first upstanding rim depending upwardly from a rear surface of said inner substrate and a second upstanding rim depending upwardly from a front surface of said inner substrate, said first upstanding rim depending upwardly from said rear surface by a first height and said second upstanding rim depending upwardly from said front surface by a second height

20. The teething device of claim 19, wherein said outer layer has a thickness substantially equal to said first height in a region of said first upstanding rim and a thickness substantially equal to said second height in a region of said second upstanding rim so that an upper surface of said outer layer is substantially planar with an upper surface of said first and second upstanding rims.

21. The teething device of claim 19, wherein said first and second heights are the same as or different from one another.

22. The teething device of claim 1, wherein said handle extends from an outer periphery of said shield so that said handle defines a handle opening substantially equal to a width of said shield.

23. The teething device of claim 22, further comprising a plurality of teething protuberances on said handle.

24. The teething device of claim 22, further comprising a plurality of concentric teething ridges on said handle.

25. The teething device of claim 1, wherein said plurality of teething ridges comprises a series of generally linear ridges.

26. The teething device of claim 25, wherein each ridge of said series of generally linear ridges comprises a radius of curvature that is not less than about 1 inch.

27. The teething device of claim 25, further comprising a plurality of teething protuberances on said nipple-like portion.

28. The teething device of claim 1, wherein said plurality of teething ridges comprises a plurality of concentric teething ridges.

29. The teething device of claim 1, wherein each ridge of said plurality of teething ridges comprises a first face and a second face depending from a surface of said nipple-like portion.

30. The teething device of claim 29, wherein said first and second faces meet at an apex having a radius of between about 0.010 inches to about 0.0 inches.

31. The teething device of claim 30, wherein said radius comprises about 0.005 inches.

32. The teething device of claim 29, wherein said first and second faces define a rake angle therebetween, said rake angle being between about 110 degrees to about 130 degrees.

33. The teething device of claim 32, wherein said rake angle is about 120 degrees.

34. The teething device of claim 1, wherein said plurality of teething ridges are formed on an upper surface of nipple-like portion and a lower surface of said nipple-like portion.
